(19) United States
(12) Patent Application Publication
(10) Pub. No.: US 2012/0198372 A1
(43) Pub. Date: Aug. 2, 2012

(54) COMMUNICATION PROCESSING BASED ON CURRENT READING STATUS AND/OR DYNAMIC DETERMINATION OF A COMPUTER USER'S FOCUS

(76) Inventor: Matthew KUHLKE, San Francisco, CA (US)

(21) Appl. No.: 13/017,769

(22) Filed: Jan. 31, 2011

(51) Int. Cl. G06F 3/048

(52) U.S. Cl. 715/767

(57) ABSTRACT

In an example embodiment, there is disclosed herein an apparatus comprising a user interface, focus detection logic operative to obtain data representative of user activity, and alert suppression logic coupled with the user interface and the focus detection logic. The alert suppression logic suppresses an alert for the user interface responsive to the focus detection logic determining from the data representative of user activity that an associated user is focused on a task.

### TECHNICAL FIELD

The present disclosure relates generally to communications processing.

### BACKGROUND

Computer users often run several programs simultaneously. This provides a computer user with the ability to switch tasks. Task switching, however, may be affected by external signals and events. A signal or event may draw a computer user's attention from an application that the user is currently engaged in to an application that is not currently using. For example, a computer user may switch from a spreadsheet program to their email application after hearing or seeing an alert indicating a new email or instant message has been received.

### BRIEF DESCRIPTION OF THE DRAWINGS

The accompanying drawings incorporated herein and forming a part of the specification illustrate the example embodiments.

FIG. 1 is a block diagram of an apparatus that determines whether to provide alerts on a user interface based on detected user activity.

FIG. 2 is a block diagram of a device such as a smart phone that can determine whether to provide alerts based on detected events on another device such as an e-reader.

FIG. 3 is a block diagram illustrating an example computer system upon which an example embodiment may be implemented.

FIG. 4 is a block diagram of a methodology for determining whether to block alerts from reaching a user interface.

FIG. 5 is a block diagram of a methodology for determining whether to block alerts from reaching a user interface that determines whether the alert is a predefined alert that is not suppressed while an associated user is focused on a task.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein, an apparatus comprising a user interface, focus detection logic operative to obtain data representative of user activity, and alert suppression logic coupled with the user interface and the focus detection logic. The alert suppression logic suppresses an alert for the user interface responsive to the focus detection logic determining from the data representative of user activity that an associated user is focused on a task.

In accordance with an example embodiment, there is disclosed herein, a method comprising obtaining data representative of an associated user's application context and determining from the data representative of an associated user's application context whether the user is focused on a task. Alerts for a user interface are suppressed by a processor responsive to determining the user is focused on a task. Alerts for the user interface are allowed by the processor responsive to determining the user is not focused on a task.

In accordance with an example embodiment, there is disclosed herein, logic encoded in at least one non-transitory tangible media for execution by a processor, and when executed operable to obtain data representative of an associated user's application context and determine from the data representative of an associated user's application context whether the user is focused on a task. The logic suppresses an alert for the user interface responsive to determining the user is focused on a task.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In an example embodiment disclosed herein, a computing device is provided with the capability to suppress incoming alerts to a user (e.g., Instant Messages “IMs”, Email, popup alerts, tweets, notifications from various applications, etc.) based on whether a user is forced on a task. This allows a user to focus on a task without being distracted. Once the user's focus has changed, for example the user has finished the task or is taking a break, alerts will be enabled. Previously suppressed alerts may be stored in a queue and presented once the user is no longer focused on the task. Any type of alert can be suppressed such as desktop alerts, pop-in alerts (e.g., GROWL alerts on a Mac computing device), as well as blinking badge, bouncing icon, red badge, and/or taskbar alerts. The implementation of alert suppression may be based on the current deployment scenario. For example, alert suppression may be implemented at the operating system (OS) level or by an application such as an event aggregator, for example GROWL on Mac computing devices.

In an example embodiment, the user's application context is continuously monitored. Events can be suppressed while a user is focusing on a task. In particular embodiments, events are suppressed for predefined tasks. Suppression of alerts may cease once the user's application context changes. Optionally, previously suppressed alerts are provided.

Any suitable criteria may be employed to determine whether a user is focused. For example, if a user stays within the same application for a predetermined (sustained) period of time. As another example a user may be determined to be focused if the user stays with the same context within an application for a predetermined (sustained) period of time. For example if the user stays within the same tab of a browser or within the same email message in an email application.

Any suitable criteria may be employed to determine when the user's focus has ended. For example, a user's focus may be determined to have ended with the user switches applications. As another example, the user's focus may be considered to have ended when the user switches context within an application, e.g., switching tabs in an IM application or switching to a new email message in an email application.

In an example embodiment, the amount of sustained time in an activity that indicates focus can be determined thorough analysis or research that provides typical multi-tasking behavior for users. For example, spending 1-2 minutes on the same application may indicate focus. In particular embodiments, the time period may be application specific.

In an example embodiment, the definition of what is considered a different context within an application may be application specific. For example, changing to another email message may indicate a break in focus, whereas switching windows within an IDE (Interactive Development Environment) like XCODE does not signify a break on focus.

In an example embodiment, alerts may be prioritized to allow certain predefined alerts such as “critical alerts” or alerts from designated sources (for example alerts from the boss). Designating which alerts may be allowed can be user configurable and in particular embodiments may be configurable by application.

In an example embodiment described herein, a computer user's phone, for example a home Internet Protocol (IP) Phone, makes call-routing decisions based upon the computer user's current focus and/or reading status. For example, rules may be dynamically applied to incoming communications so that a computer user is undisturbed during reading sessions that the user wishes to focus on. A user's current reading status can be obtained from any suitable device such as a standalone e-reader (for example a KINDLE type device), e-reader software running on a multifunction device (such as a KINDLE application or an (BOOKS application running on a tablet type device like an IPAD). The user's reading status may include, but is not limited to, the following information: type of book or article (e.g., newspaper, fiction, non-fiction, author, etc.), length of time the user has been reading in the current session, how many pages the user has read in the current session, length of time the since the user last turned a page, how many other items the user has read in the current session, what is the user's progress (e.g. percentage of completion) for the current item the user is reading.

In an example embodiment, a reader's “session” is gauged based on a period of activity and/or inactivity. For example, if the user has not turned a page within a predefined amount of time, an assumption is made that the reading session has ended.

In an example embodiment, legacy data may be available. Legacy data may include, but is not limited to, average time the user spends in one reading session, whether the user has previously read the current item the user is reading, details of previous reading sessions such as content, duration, etc.

In an example embodiment, a user could just select a predefined setting on their reading device. For example “Please apply my preferred processing settings while reading device is in use.” The settings may include a setting for a phone, such as an IP phone, but may also be used with any phone that can communicate with the reading device such as a WiFi and/or BLUETOOTH enabled telephone, that instructs the phone to forward all calls to voice mail. In particular embodiments, the user may provide a predefined list of callers that the user will accept calls from.

An aspect of an example embodiment is the ability to dynamically determine whether a user is “focused” on a task (e.g., reading) and apply the appropriate call processing rules. A user may be determined to be focused on the material the user is reading based on whether the user has been reading the same content continuously for a predetermined amount of time (for example 30 minutes), whether the user is reading a long-format content and has read a high percentage of the same format content (for example a novel) within a predefined time such as the previous two weeks, etc., whether the user is in a particularly interesting section of the content (for example an author may indicate where the climax of a novel is located) or via social cues. For example, an e-reader can determine from reading notes or comments from other users whether the user is in a particularly interesting section of a novel, or may determine from other data (such as 90% of all users reading the novel read chapters 11-14 without stopping) that the user is in a particularly interesting section of a document.

In an example embodiment, a user may also specify a plurality of options. For example, a user may request that all calls are forwarded to voicemail while reading a novel, or request calls are forwarded to voicemail after reading a document for a predefined time (such as 10 minutes). In particular embodiments, the user may specify rules based on the content. For example the user may specify one rule while reading the New York Times and a different rule while reading the Wall Street Journal.

Additional embodiments may include the ability to provide incoming call data on the reading device which the user can choose to ignore by initiating a predefined action such as pushing a button. In a particular embodiment, if the user selects to ignore a call the user may be prompted by the reading device to indicate whether the user wishes to ignore all calls (or calls from the current caller) while reading the current content.

In an example embodiment, eye-tracking technology is employed to determine whether a user is reading, and the manner of reading, e.g., skimming versus focused. In particular embodiments, alerts may be suppressed while the reader is performing focused reading, but allowed while the user is skimming.

End of reading may be determined by an analysis of the user's eye movements. For example, once a user is determined to be reading, the user will be determined to be done when the user's eyes rapidly move away in a manner that suggests the user is no longer moving within the flow of the document.

Fine tuning and thresholds can be done to allow the user time to scroll down or hit a ‘next page’ on a document reader without triggering alerts. The ‘strictness’ of the reading determination could also be user configurable.

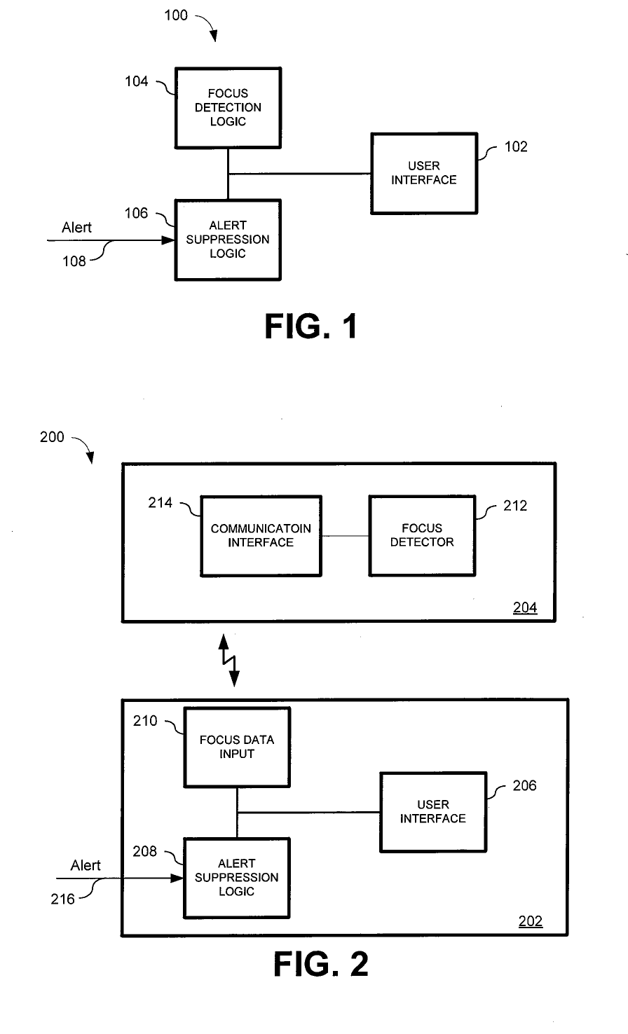

FIG. 1 is a block diagram of an apparatus 100 that determines whether to provide alerts on a user interface based on detected user activity. In the illustrated example, apparatus 100 comprises a user interface 102, focus detection logic 104 and alert suppression logic 106. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

User interface 102 may be any suitable device for providing data to an associated user. For example, user interface may suitably comprise an audio device such as a speaker, a video device such as a display or a combination of audio and video devices.

Focus detection logic 104 obtains data representative of user activity. Focus detection logic 104 may obtain this data from user interface 102 or as will be explained in more detail herein infra, from an external device.

Alert suppression logic 106 is coupled with user interface 102 and focus detection logic 104. Alert suppression logic 106 is responsive to focus detection logic 104 determining from the data representative of user activity that an associated user is focused on a task to suppress an alert 108 from being output on user interface 102. Alert 108 may be any type of alert, for example any one of an incoming Instant Message (IM) alert, an incoming e-mail alert, a popup window from an application not associated with the task the user is in focus, a tweet, a text message, a multimedia messaging service message, an incoming telephone call, or any combination of the aforementioned alerts.

In an example embodiment, the associated user is determined to be focused on a task responsive to focus detection logic 102 determining that the associated user has remained within an application for at least a predetermined time. In particular embodiments, focus detection logic 102 determines that the associated user is focused on a task responsive to determining the associated user remains with a same context within the application for at least a predetermined time. For example of the user remains reading and/or editing the same document in a word processing application, reading and/or responding to an email message within an email application, etc.

In an example embodiment, focus detection logic 104 determines that the associated user is determined to have ended focus on the task responsive to the user switching context within the application. For example, once the user switches documents in a spreadsheet application. In another example embodiment, focus detection logic 104 determines that the associated user ended focus on the task responsive to the user switching to another application, for example from a spreadsheet application to a reading application.

In an example embodiment, alert suppression logic 106 may be configured to allow certain predefined alerts. For example, alerts from a certain source (such as an incoming call from a family member) or alerts having a priority greater than a specified priority. In an example embodiment, the predefined alerts may be input by an associated user based on application (e.g., alerts from one group of users may be allowed while the associated user is focused on surfing the Internet while alerts from another group of users may be allowed while the user is focused on a word processing application. For example, a first alert, having a priority less than a specified priority level or from a source not on an approved list may be suppressed by alert suppression logic 106 while a second alert having a priority greater than the specified priority and/or from a source on an approved list will be provided to user interfaced 102.

In an example embodiment, focus detection logic 104 determines whether the user is focused on a task based on tracking eye movement. For example, user interface 102 or another device (not shown) coupled with apparatus 100 may employ eye tracking technology to track an associated user's eye movement. Based on the user's eye movement, focus detection logic 104 can determine whether the user is focused on a task.

In an example embodiment, the data representative of user activity that an associated user is focused on a task is received by focus detection logic 102 from an external device. For example, an e-reader may be coupled two a network (such as WiFi, the Internet, and/or a PAN such as BLUETOOTH) that enables the e-reader to send data to focus detection logic 104 to indicate whether the associated user is focused on a task associated with the external device.

In an example embodiment, alert 108 is for an incoming telephone call. For example a ring tone and/or a visual display data such as caller identification (ID) is destined for user interface 102 for outputting. Alert suppression logic 106, responsive to determining that the user is focused on a task forwards the incoming telephone call to voice mail. In particular embodiments, alert suppression logic can be configured to determine whether to suppress alert 108 based on the application the user is focused on. For example, if the user is focused on a web browser alert suppression logic 106 may provide alert 108 to user interface 108 whereas if the user is focused on editing a document alert suppression logic 106 may suppress alert 108 from reaching user interface 102.

In an example embodiment, alert suppression logic 106 stores alert 108 while the user is focused on a task. Alert 108 is forwarded to user interface 102 responsive to alert suppression logic 106 determining that the associated user is no longer focused on the task. Multiple alerts may be queued while the user is focused on a task. Upon determining the user's focus has ended, the alerts may be output by user interface 102. The alerts may be output in any order, e.g., by time, by priority, and/or by source.

In an example embodiment, focus detection logic 104 determines whether the associated user is focused on the task based on how long since a page in an associated document has been changed. For example, if the user has been reading a book and hasn't turned the page in more than a preset amount of time (e.g., five minutes), then the user is determined to not be focused on the task.

In an example embodiment, focus detection logic 104 determines whether the associated user is focused on the task based on a percentage of pages read in a document during a current session. The percentage of pages read may vary by size of document and/or by user configurable.

In an example embodiment, focus detection logic 104 determines whether the associated user is focused on the task based on whether the user is within a predetermined section of a document. For example, if the user is reading a novel, alerts may be suppressed while the user is near the climax of the story.

In an example embodiment, focus detection logic 106 determines whether the associated user is focused on the task based an amount of time the associated user is reading a document and the type of document being read. For example, the time period for being focused while reading a novel may be different than the time period for reading a technical article. As another example, a user may be considered focused on a task if the user is reading/surfing on a particular web site for at least a predetermined amount of time.

FIG. 2 is a block diagram of a system 200 comprising a device 202 such as a smart phone that can determine whether to provide alerts based on detected events on another device 204 such as an e-reader. In the illustrated example, device 202 comprises a user interface 206, alert suppression logic 208 and a focus data input 210, e.g., an interface or any other suitable means for receiving focus data. The focus data input receives focus data from device 204.

Device 204 comprises a focus detector 212 and a communication interface 214. Focus detector 212 determines whether the user is focused on a task with the device. Focus detector 212 may determine whether the user is focused by any suitable means such as are described herein. For example, focus detector 212 may employ eye tracking technology and determine from the associate user's eye movement whether the user is focused on a task. As another example, focus detector may determine user focus (or application context) based on various activities such as time spent in an application and/or context within application, percent of pages of a document read in a current session, is the user is reading/editing a particular section of a document, or any combination of the aforementioned activities. Focus detector 212 can communicate to other devices whether the user is focused on a task via communication interface 214.

Device 202 receives focus data from device 204 via focus data input 210. In an example embodiment, the data from device 204 comprises activity data and alert suppression logic 206 determines from the data whether the user is focused on a task. In another example embodiment, the data may simply indicate when the user is focused in a task. When an alert 216 is received by alert suppression logic 206, alert suppression logic determines whether to forward the alert to user interface 206 based on whether the user is focused on a task with device 204.

For example, device 204 may be a computing device such as a desktop computer, laptop computer, tablet, e-reader, etc., and device 202 may be a telephone. If an incoming call (alert 216) is received by the telephone (device 202), alert suppression logic 208 determines whether to forward the call to the user interface (e.g., output a ring tone, vibrate, and/or provide caller ID data on a display) based on the data received from device 204. If the user is focused on a task, alert 216 is suppressed. Optionally, the incoming call may be forwarded, for example to voice mail or to another call such as a secretary's phone while the user is focused on a task. Device 202 may output the missed call (alert 216) and/or voice mail data responsive to receiving data from device 204 indicating that the user is no longer focused on the task.

Devices 202, 204 may communicate using any suitable means. For example, devices 202, 204 may be coupled to a network (for example the devices could be coupled to the Internet and communicate using Internet Protocol “IP” signals). As another example, the devices may communicate using WiFi and/or BLUETOOTH. Other embodiments may include a combination of wired and wireless links and/or protocols.

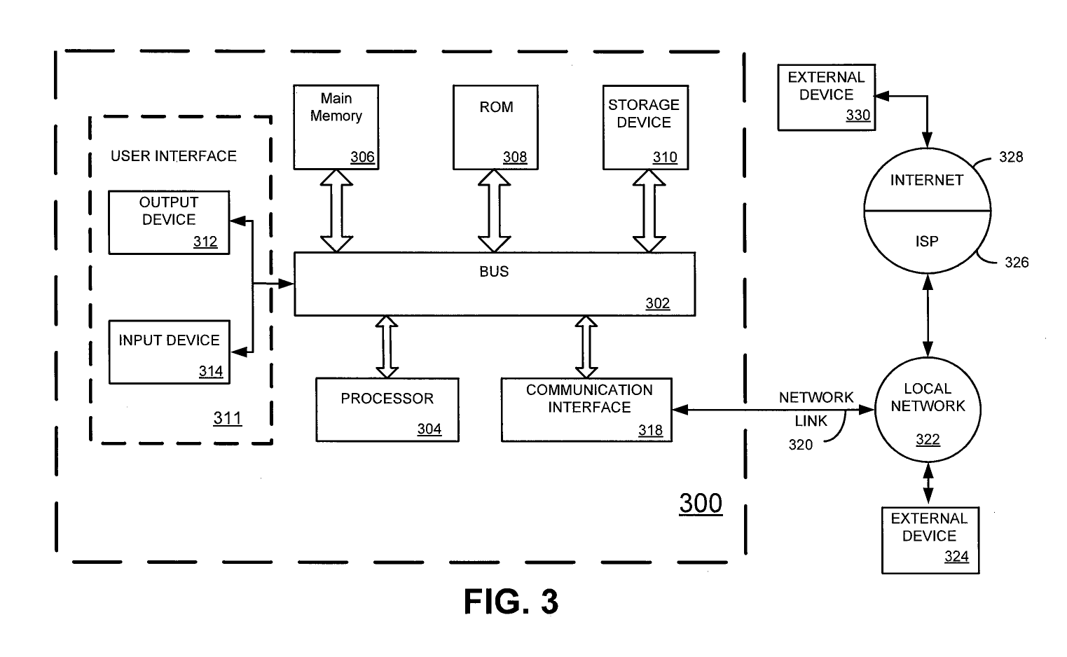

FIG. 3 is a block diagram illustrating an example computer system 300 upon which an example embodiment may be implemented. Computer system 300 may be employed for implementing focus detection logic 104 (FIG. 1), alert suppression logic 106 (FIG. 1), and/or alert suppression logic 208 (FIG. 2).

Computer system 300 includes a bus 302 or other communication mechanism for communicating information and a processor 304 coupled with bus 302 for processing information. Computer system 300 also includes a main memory 306, such as random access memory (RAM) or other dynamic storage device coupled to bus 302 for storing information and instructions to be executed by processor 304. Main memory 306 also may be used for storing a temporary variable or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a user interface 311, which in the illustrated example comprises an output device 312 and an input device 314. Output device 312 may suitably comprise a display such as a cathode ray tube (CRT) or liquid crystal display (LCD), for displaying information to a computer user. Input device 314 can be any suitable input device such as a keyboard including alphanumeric and other keys is coupled to bus 302 for communicating information and command selections to processor 304. In particular embodiments, the input device comprises a cursor control, such as a mouse, a trackball, and/or cursor direction keys. In an example embodiment, output device 312 and input device 314 are components of a touchscreen that can be employed for communicating direction information and command selections to processor 304 and for controlling cursor movement.

An aspect of the example embodiment is related to the use of computer system 300 for communication processing based on current reading status and/or dynamic determination of user computer user's focus. According to an example embodiment, communication processing based on current reading status and/or dynamic determination of a computer user's focus is provided by computer system 300 in response to processor 304 executing one or more sequences of one or more instructions contained in main memory 306. Such instructions may be read into main memory 306 from another computer-readable medium, such as storage device 310. Execution of the sequence of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 304 for execution. Such a medium may take many forms, including but not limited to non-volatile media, and volatile media. Non-volatile media include for example optical or magnetic disks, such as storage device 310. Volatile media include dynamic memory such as main memory 306. 3As used herein, tangible media may include volatile and non-volatile media. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Various forms of computer-readable media may be involved in carrying one or more sequences of one or more instructions to processor 304 for execution. For example, the instructions may initially be borne on a magnetic disk of a remote computer. The remote computer can load the instructions into its dynamic memory and send the instructions over a telephone line using a modem. A modem local to computer system 300 can receive the data on the telephone line and use an infrared transmitter to convert the data to an infrared signal. An infrared detector coupled to bus 302 can receive the data carried in the infrared signal and place the data on bus 302. Bus 302 carries the data to main memory 306 from which processor 304 retrieves and executes the instructions. The instructions received by main memory 306 may optionally be stored on storage device 310 either before or after execution by processor 304.

In an example embodiment, computer system 300 also includes a communication interface 318 coupled to bus 302. Communication interface 318 provides a two-way data communication coupling computer system 300 to a network link 320 that is connected to a local network 322. This can allow computer system to communicate with other devices. For example if computer system 300 is employed to implement device 202, communication interface 318 would enable device 202 to communicate with device 204.

For example, communication interface 318 may be a local area network (LAN) card to provide a data communication connection to a compatible LAN. As another example, communication interface 318 may be an integrated services digital network (ISDN) card or a modem to provide a data communication connection to a corresponding type of telephone line. Wireless links may also be implemented. In any such implementation, communication interface 318 sends and receives electrical, electromagnetic, or optical signals that carry digital data streams representing various types of information.

In the example illustrated in FIG. 3, computer system 300 can communicate via local network 322 with external device 324. Local network 322 may be any suitable network. For example local network 322 may employ a wired, wireless, or a combination of wired and wireless segments to link computer system 300 to external device 324. In an example embodiment, computer system 300 and external device 324 may employ a Personal Area Network (PAN) protocol such as BLUETOOTH to form an ad hoc network with each other.

As another example, which is also illustrated in FIG. 3, computer system 300 may communicate through an Internet Service Provider (ISP) 326 either directly or via local network 322 via the Internet 328 to external device 330. This as one skilled in the art can readily appreciate, communication interface 318 may employ any suitable means for communicating with external devices to obtain and/or provide user activity (e.g., application context/focus) data.

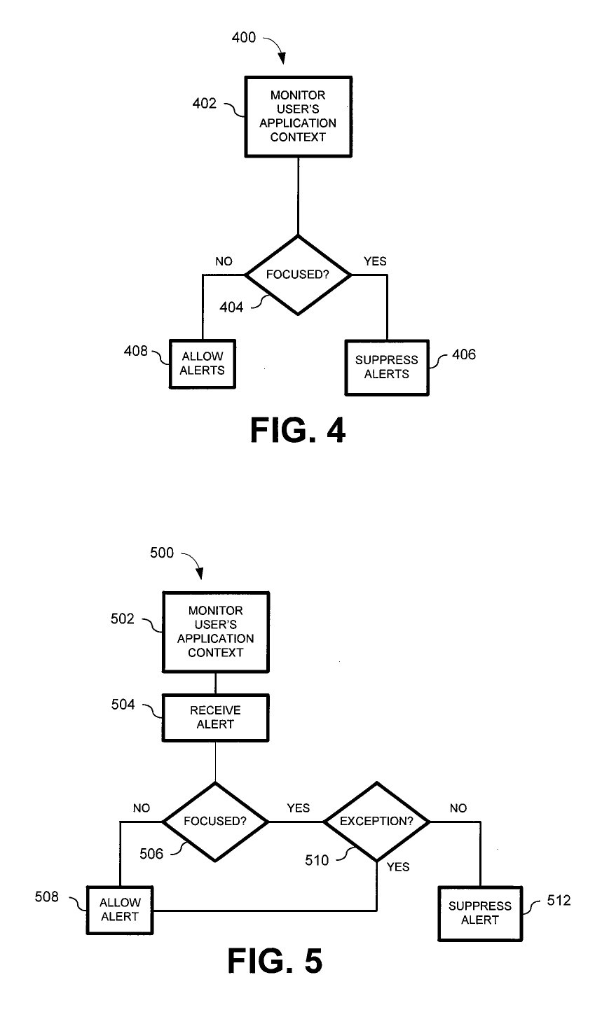

In view of the foregoing structural and functional features described above, methodologies in accordance with example embodiments will be better appreciated with reference to FIGS. 4 and 5. While, for purposes of simplicity of explanation, the methodologies of FIGS. 4 and 5 are shown and described as executing serially, it is to be understood and appreciated that the example embodiments are not limited by the illustrated orders, as some aspects could occur in different orders and/or concurrently with other aspects from that shown and described herein. Moreover, not all illustrated features may be required to implement the methodologies in accordance with an example embodiment. The methodologies described herein are suitably adapted to be implemented in hardware, software, or a combination thereof, such as a processor executing software.

Referring to FIG. 4, there is illustrated a block diagram of a methodology 400 for determining whether to block alerts from reaching a user interface. Methodology 400 may be implemented by apparatus 100 (FIG. 1), device 202 (FIG. 2), and/or computer system 300 (FIG. 3).

At 402, an associated user's application context is monitored. The monitoring may suitably comprise determining time spent on certain activities, e.g., time spent on a application and/or time spent on a certain activity within an application such as time spent viewing/editing a spreadsheet, drawing, e-mail message, website, or other type of document. In an example embodiment, monitoring a user's application context may suitably comprise monitoring a physical characteristic such as tracking the user's eye movement.

At 404, a determination is made based on the user's application context on whether a user is focused on a task. Any suitable criteria may be employed for determining whether the user is focused on a task. For example, if a user stays within the same application for a predetermined (sustained) period of time. As another example a user may be determined to be focused if the user stays with the same context within an application for a predetermined (sustained) period of time. For example if the user stays within the same tab of a browser or within the same email message in an email application. In an example embodiment, the amount of sustained time in an activity that indicates focus can be determined thorough analysis or research that provides typical multi-tasking behavior for users. For example, spending 1-2 minutes on the same application may indicate focus. In particular embodiments, the time period may be application specific. In an example embodiment, the user's application context may be monitored by an external device and provided to a device making the determination.

If, at 404, a determination is made that the user is focused on a task (YES), alerts are suppressed as indicated at 406. In an example embodiment, alerts are queued until the user is out of focus and then forwarded to a user interface or other output device such as a display, speaker, mechanical vibration, etc. In partticular embodiments, an incoming communication may be diverted. For example, if a telephone call is received while the user is focused on a task, the call may be diverted to voice mail or to another phone associated with the user such as the user's secretary. If, however, at 404, a determination is made that the user is not focused on a task (NO), alerts are allowed as indicated by 408.

Referring to FIG. 5, there is illustrated is a block diagram of a methodology 500 for determining whether to block alerts from reaching a user interface that determines whether the alert is a predefined alert that is not suppressed while an associated user is focused on a task. Methodology 400 may be implemented by apparatus 100 (FIG. 1), device 202 (FIG. 2), and/or computer system 300 (FIG. 3).

At 502, an associated user's application context is monitored. The monitoring may suitably comprise determining time spent on certain activities, e.g., time spent on a application and/or time spent on a certain activity within an application such as time spent viewing/editing a spreadsheet, drawing, e-mail message, website, or other type of document. In an example embodiment, monitoring a user's application context may suitably comprise monitoring a physical characteristic such as tracking the user's eye movement.

At 504, an alert is received for the user. The alert may be any type of such as desktop alerts, pop-in alerts (e.g., GROWL alerts on a Mac computing device), as well as blinking badge, bouncing icon, red badge, and/or taskbar alerts. The alert may indicate an IM, an incoming e-mail, a popup window from an application not associated with the task the user is in focus, a tweet, a text message, a multimedia messaging service (MMS) message, and/or an incoming telephone call.

At 506, a determination is made based on the user's application context on whether a user is focused on a task. Any suitable criteria may be employed for determining whether the user is focused on a task. For example, if a user stays within the same application for a predetermined (sustained) period of time. As another example a user may be determined to be focused if the user stays with the same context within an application for a predetermined (sustained) period of time. For example if the user stays within the same tab of a browser or within the same email message in an email application. In an example embodiment, the amount of sustained time in an activity that indicates focus can be determined thorough analysis or research that provides typical multi-tasking behavior for users. For example, spending 1-2 minutes on the same application may indicate focus. In particular embodiments, the time period may be application specific. In an example embodiment, the user's application context may be monitored by an external device and provided to a device making the determination.

If at 506, a determination is made that the user is not focused on a task (NO), the alerts is allowed (output) as indicated by 508. However, if at 508 a determination is made that the user is focused on a task (YES), at 510 a determination is made whether the alert is a predefined alert (or exception) that is not suppressed while the user is focused on a task. Predefined alerts may vary based on any criteria such as by task, source of alert, and/or priority. For example tasks of a first level of priority may be allowed while the user is focused on one task (such as web browsing), whereas for a second application (for example a programming application) tasks of a second, e.g., higher, priority level are permitted.

If at 510, a determination is made that the alert is a predefined alert (YES), the alert will be processed as illustrated at 508. However, if at 510, a determination is made that the task is not of a predefined task that is not suppressed while the user is focused on a task (NO), the alert is suppressed as indicated by 512. In an example embodiment, suppressed tasks are queued until the user is no longer focused on a task and then presented to the associated user via the user interface.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
a user interlace;
focus detection logic operative to obtain data representative of user activity; and
alert suppression logic coupled with the user interface and the focus detection logic;
wherein the alert suppression logic is responsive to the focus detection logic determining from the data representative of user activity that an associated user is focused on a task to suppress an alert from being output on the user interface.

2. The apparatus of claim 1, wherein the associated user is determined to be focused on a task responsive to the focus detection logic determining the associated user remains within an application for at least a predetermined time.

3. The apparatus of claim 2, wherein the associated user is determined to be focused on a task responsive to the focus detection logic determining the associated user remains with a same context within the application for at least a predetermined time.

4. The apparatus of claim 3, wherein the associated user is determined to have ended focus on the task responsive to the focus detection logic determining that the user switched context within the application.

5. The apparatus of claim 2, wherein the associated user is determined to have ended focus on the task responsive the focus detection logic determining that the user switched to another application.

6. The apparatus of claim 1, wherein the alert suppression logic forwards a second alert with an associated priority to the user interlace while the associated user is determined to be focused on a task responsive to determining the associated priority is at least a predetermined threshold.

7. The apparatus of claim 1, wherein the alert suppression logic forwards a second alert with an associated source to the user interface while the associated user is determined to be focused on a task responsive to determining the source is exempt from alert suppression.

8. The apparatus of claim 1, wherein the focus detection logic determines whether the user is focused on a task based on tracking eye movement.

9. The apparatus of claim 1, wherein the alert is a member of a group consisting of an incoming Instant Message alert, an incoming e-mail alert, a popup window from an application not associated with the task the user is in focus, a tweet, a text message, a multimedia messaging service message, and an incoming telephone call.

10. The apparatus of claim 1, wherein the data representative of user activity that an associated user is focused on a task is received by the focus detection logic from an external device.

11. The apparatus of claim 1, wherein the incoming alert is for an incoming telephone call; and
wherein the alert suppression logic forwards the incoming telephone call to voice mail.

12. The apparatus of claim 1, wherein the alert suppression logic stores the alert; and
wherein the alert is forwarded to the user interface responsive to the alert suppression logic determining that the associated user is no longer focused on the task.

13. The apparatus of claim 1, wherein the focus detection logic determines whether the associated user is focused on the task based on how long since a page in an associated document has been changed.

14. The apparatus of claim 1, wherein the focus detection logic determines whether the associated user is focused on the task based on a percentage of pages read in a document during a current session.

15. The apparatus of claim 1, wherein the focus detection logic determines whether the associated user is focused on the task based on whether the user is within a predetermined section of a document.

16. The apparatus of claim 1, wherein the focus detection logic determines whether the associated user is focused on the task based an amount of time the associated user is reading a document and the type of document being read.

17. A method, comprising:
obtaining data representative of an associated user's application context;
determining from the data representative of an associated user's application context whether the user is focused on a task;
suppressing alerts for the user interface by a processor responsive to determining the user is focused on a task; and
allowing alerts for the user interface by the processor responsive to determining the user is not focused on a task.

18. The method of claim 17, further comprising determining whether an alert is a predefined alert to be forwarded to the user interface while the user is focused on a task; and
wherein allowing alerts further comprises forwarding the alert to the user interface responsive to determining the user is focused on a task and that the alert is a predefined alert.

19. The method of claim 17, wherein the data representative of an associated user's application context is received from an external device, the method further comprising:
receiving an incoming telephone call; and
routing the incoming telephone call to voice mail responsive to determining the user is focused on a task.

20. Logic encoded in at least one non-transitory tangible media for execution by a processor, and when executed operable to:
obtaining data representative of an associated user's application context;
determining from the data representative of an associated user's application context whether the user is focused on a task;
suppressing an alert for the user interface responsive to determining the user is focused on a task.
